(19) United States
(12) Patent Application Publication
(10) Pub. No.: US 2012/0013294 A1
(43) Pub. Date: Jan. 19, 2012

(54) Enclosure bidirectional wireless charging/discharging device

(76) Inventor: Ming-Hsiang Yeh, Taipei City (TW)

(21) Appl. No.: 13/067,978

(22) Filed: Jul. 13, 2011

(30) Foreign Application Priority Data
Jul. 19, 2010 (TW) 099213707

(51) Int. Cl. H02J 7/00

(52) U.S. Cl. 320/108

(57) ABSTRACT

An enclosure bidirectional wireless charging/discharging device selectively performs electrical charging and discharging operation through selectively transmitting and receiving resonance energy with respect to a corresponding charging/discharging device that includes a second receiver/transmitter device. The bidirectional wireless charging/discharging device includes: a carrier body, a first receiver/transmitter device, and an enclosure member. The first receiver/transmitter device is arranged inside the carrier body. The first receiver/transmitter device includes at least one connector, which is exposed outside the carrier body. The first and second receiver/transmitter devices selectively transmit to and receive from each other the resonance energy in a wireless manner. The resonance energy is then converted into electrical power, which is transmitted through the connector, or the electrical power is converted into resonance energy for transmission and reception in a wireless manner. The enclosure member encloses the carrier body, so that the enclosure member and the carrier body together define a retention zone therebetween.

### FIELD OF THE INVENTION

The present invention relates generally to an enclosure bidirectional wireless charging/discharging device, and in particular to a bidirectional wireless charging/discharging device that selectively performs electrical charging and discharging operation through selectively transmitting and receiving resonance energy that is subsequently converted for being applicable to the operations of charging, discharging, and instantaneous supply of electrical power to various handheld electronic devices.

### BACKGROUND OF THE INVENTION

With the advancing of technology, a lot of electronic devices are made compact and thus can be held by a hand, such as mobile phones, personal digital assistants (PDAs), electronic navigation devices, mobile internet devices (MIDs), and electronic books.

The handheld electronic devices are convenient for being easily carried and timely operating. However, with the increasingly upgrading of functionality and operation speed, it general problem of the handheld electronic devices is the operation period that can be supported by the battery pack provided in the device. A common solution for such a problem is to carry AC-to-DC adaptors for those electronic devices. This solution is certainly troublesome and inconvenient for the general consumers. Further, each handheld electronic device can only work with a specific type of adaptor and it is generally impossible for different electronic devices to use the same adaptor. Once a handheld electronic device is no longer used or is replaced by an upgraded product, the adaptor that is specific to such a handheld electronic device must be then discarded. This causes pollution to the environment and is extremely disadvantageous to environmental protection.

Thus, it is desired to provide a common charging and discharging device for various handheld electronic devices, so that a user does not need to carry a number of AC-to-DC adaptors.

### SUMMARY OF THE INVENTION

A primary objective of the present invention is to provide an enclosure bidirectional wireless charging/discharging device that can serve as a common charging and discharging device for various handheld electronic devices (such as mobile phone, personal digital assistant, electronic navigation device, mobile internet device, and electronic book) so that there is no need for a user to carry a number of different AC-to-DC adaptors, realizing convenience of use and protection against environmental pollution.

A secondary objective of the present invention is to provide an enclosure bidirectional wireless charging/discharging device, which comprises an enclosure member for protecting and positioning a handheld electronic device received therein.

A further objective of the present invention is to provide an enclosure bidirectional wireless charging/discharging device, which comprises an enclosure member that encloses a carrier body and even a handheld electronic device positioned in the bidirectional wireless charging/discharging device to thereby provide better protection and aesthetics.

To achieve the above objectives, the present invention provides an enclosure bidirectional wireless charging/discharging device, which selectively performs electrical charging and discharging operation through selectively transmitting and receiving resonance energy with respect to a corresponding charging/discharging device that comprises a second receiver/transmitter device. The bidirectional wireless charging/discharging device comprises: a carrier body, a first receiver/transmitter device, and an enclosure member. The first receiver/transmitter device is arranged inside the carrier body. The first receiver/transmitter device comprises at least one connector, which is exposed outside the carrier body. The first and second receiver/transmitter devices selectively transmit to and receive from each other the resonance energy in a wireless manner. The resonance energy is then converted into electrical power, which is transmitted through the connector, or the electrical power is converted into resonance energy for transmission and reception in a wireless manner. The enclosure member encloses the carrier body, so that the enclosure member and the carrier body together define a retention zone therebetween.

As such, a common charging and discharging device is provided for various handheld electronic devices so that there is no need for a user to carry a number of different AC-to-DC adaptors, realizing convenience of use and protection against environmental pollution, and providing a function of bidirectional wireless charging and discharging for the electronic devices.

### BRIEF DESCRIPTION OF THE DRAWINGS

The present invention will be apparent to those skilled in the art by reading the following description of preferred embodiments thereof with reference to the drawings, in which:

FIG. 1 is an exploded view of an enclosure bidirectional wireless charging/discharging device according to a first embodiment of the present invention;

FIG. 2 is a perspective view of the enclosure bidirectional wireless charging/discharging device of the first embodiment of the present invention in an assembled form, showing the enclosure bidirectional wireless charging/discharging device separated from a corresponding charging/discharging device and a handheld electronic device;

FIG. 3 is a cross-sectional view of the enclosure bidirectional wireless charging/discharging device of the first embodiment of the present invention taken along line 3-3 of FIG. 2;

FIG. 4 is an exploded view of an enclosure bidirectional wireless charging/discharging device according to a second embodiment of the present invention;

FIG. 5 is a perspective view of the enclosure bidirectional wireless charging/discharging device according to the second embodiment of the present invention in an assembled form;

FIG. 6 is a cross-sectional view of the enclosure bidirectional wireless charging/discharging device according to the second embodiment of the present invention;

FIG. 7 is a cross-sectional view of the enclosure bidirectional wireless charging/discharging device according to the second embodiment of the present invention with a first power source device additionally included;

FIGS. 8A and 8B are schematic block diagrams of circuits of the bidirectional wireless charging/discharging device according to the present invention; and

FIG. 9 is perspective view showing the enclosure bidirectional wireless charging/discharging device used in combination with a handheld electronic device and a corresponding charging/discharging device of different type, they being shown in a separated condition.

### DETAILED DESCRIPTION OF THE PREFERRED EMBODIMENTS

The present invention provides an enclosure bidirectional wireless charging/discharging device. The bidirectional wireless charging/discharging device according to the present invention is primarily provided for electrical charging and discharging of a corresponding charging/discharging device 2 that comprises a second receiver/transmitter device 21 by receiving resonance energy (65 or 75) through bidirectional transmission/reception and subsequently performing conversion and is applicable to charging and/or discharging a handheld electronic device 3 (such as mobile phone, personal digital assistant (PDA), electronic navigation device, mobile internet device (MID), and electronic book) that is put in electrical connection with the bidirectional wireless charging/discharging device according to the present invention.

### First Embodiment

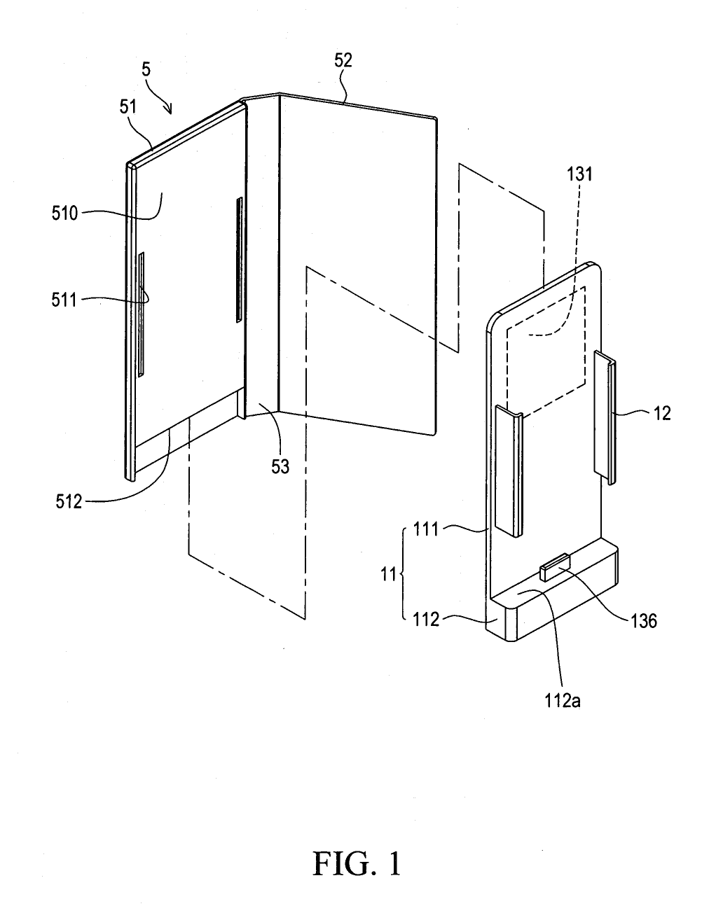

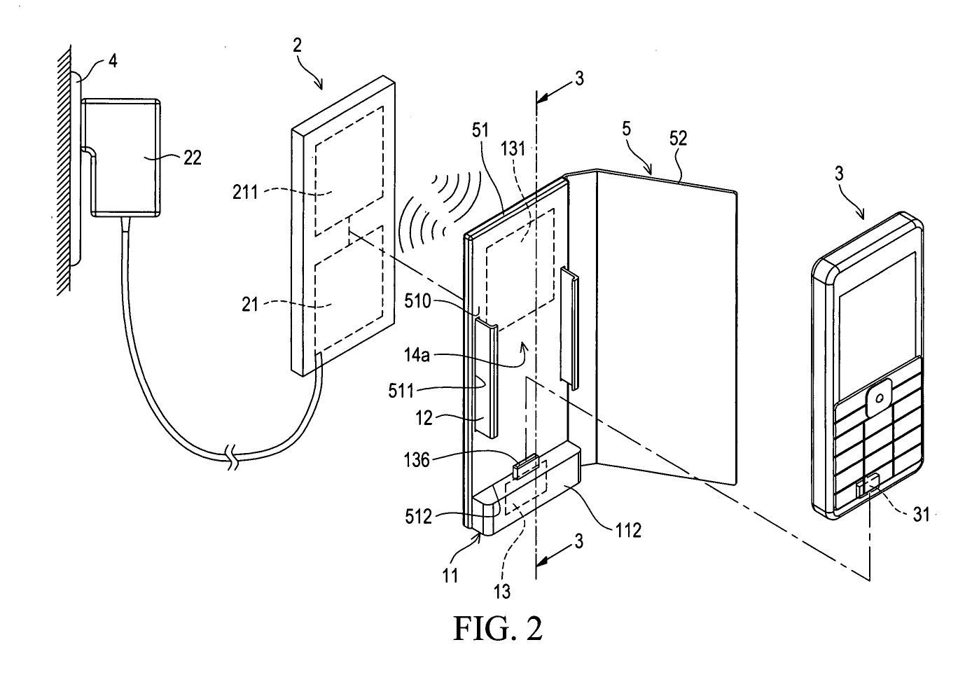

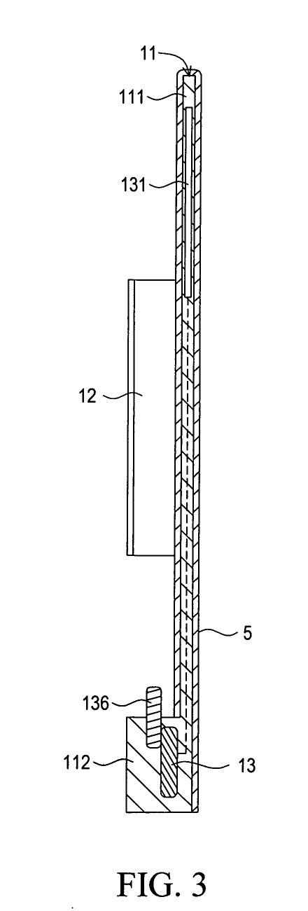

With reference to the drawings and in particular to FIGS. 1-3, which show a bidirectional wireless charging/discharging device constructed in accordance with a first embodiment of the present invention, the bidirectional wireless charging/discharging device of the present invention (as shown in FIGS. 1 and 3) is provided for performing charging and/or discharging operation through bidirectional wireless transmission/reception of resonance energy with respect to a corresponding charging/discharging device 2 (see FIG. 2). The corresponding charging/discharging device 2 comprises a second receiver/transmitter device 21. The corresponding charging/discharging device 2 further comprises a power member 22 electrically connected to the second receiver/transmitter device 21. The power member 22 is pluggable in a power socket 4 to acquire electrical power.

The bidirectional wireless charging/discharging device comprises a carrier body 11, a first receiver/transmitter device 13, and an enclosure member 5. The first receiver/transmitter device 13 is arranged inside the carrier body 11. The first receiver/transmitter device 13 comprises at least one connector 136. The connector 136 is exposed outside the carrier body 11 for electrical coupling a mating connector 31 of a handheld electronic device 3. The corresponding charging/discharging device 2 comprises the above-mentioned second receiver/transmitter device 21. The first and second receiver/transmitter devices 13, 21 may transmit to and/or receive from each other resonance energy in a wireless manner. The resonance energy can be converted into electrical power, which is transmitted through the connector 136 and the mating connector 31, and/or the electrical power can be converted into resonance energy for transmission and reception in a wireless manner. Thus, the bidirectional wireless charging/discharging device according to the present invention allows the corresponding charging/discharging device 2 to perform charging, discharging, and instantaneous supplying of electrical power to the handheld electronic device 3. (The handheld electronic device 3 may discharge electrical power thereof to reversely supply to the corresponding charging/discharging device 2 or any other electronic device that comprises a second receiver/transmitter device 21.)

The enclosure member 5 encloses the carrier body 11 in such a way that the enclosure member 5 and the carrier body 11 together define a retention zone 14a therebetween for receiving, positioning, retaining therein the handheld electronic device 3 and also realizing protection and aesthetics.

Preferably, the carrier body 11 comprises a back board 111 and a seat 112 mounted to a lower edge portion of the back board 111. The back board 111 also forms a pair of holding arms 12. Except a first resonant circuit device 131 that will be described later, the first receiver/transmitter device 13 is completely arranged inside the seat 112. (As shown in FIG. 3, the first resonant circuit device 131 is arranged inside the back board 111.) The connector 136 of the first receiver/transmitter device 13 is exposed on an upper side wall 112a of the seat 112. Further, as shown in FIGS. 1 and 2, the enclosure member 5 is made of leather or similar materials and comprises an enclosure sheet 51 and a flap cover 52 connected to a side edge of the enclosure sheet 51. The enclosure member 5 is arranged to have the enclosure sheet 51 thereof enclosing the carrier body 11. Specifically, the enclosure sheet 51 has an inside surface 510 that forms two first openings 511 and a second opening 512 respectively corresponding to the two holding arms 12 and the seat 112. The two holding arms 12 respectively extend through the two first openings 511 to project outside the enclosure member 5, and the seat 112 extends through the second opening 512 to project outside the enclosure member 5, whereby the two holding arms 12, the seat 112, and the inside surface 510 of the enclosure member 5 collectively define the retention zone 14a. Further, the enclosure member 5 comprises a spacer plate 53, which connects between opposing side edges of the enclosure sheet 51 and the flap cover 52 to allow the enclosure member 5, after being closed, to form a thickness sufficient to accommodate the handheld electronic device 3.

Referring to FIG. 2, in case where the handheld electronic device 3 is to be charged, the handheld electronic device 3 is positioned in the retention zone 14a of the bidirectional wireless charging/discharging device of the present invention to have the connector 31 thereof electrically mating the connector 136, and then, the bidirectional wireless charging/discharging device is positioned to be close to and adjacent to the corresponding charging/discharging device 2 to allow of wireless transmission and reception between the first and second receiver/transmitter devices 13, 21 for wireless transmission and reception of resonance energy. The resonance energy may then be converted into electrical power that is transmitted through the connector 136 and the mated connector 31, and/or the electrical power is converted into resonance energy for wireless transmission and reception, thereby realizing charging, discharging, and instantaneous supply of electrical power to the handheld electronic device 3.

### Second Embodiment

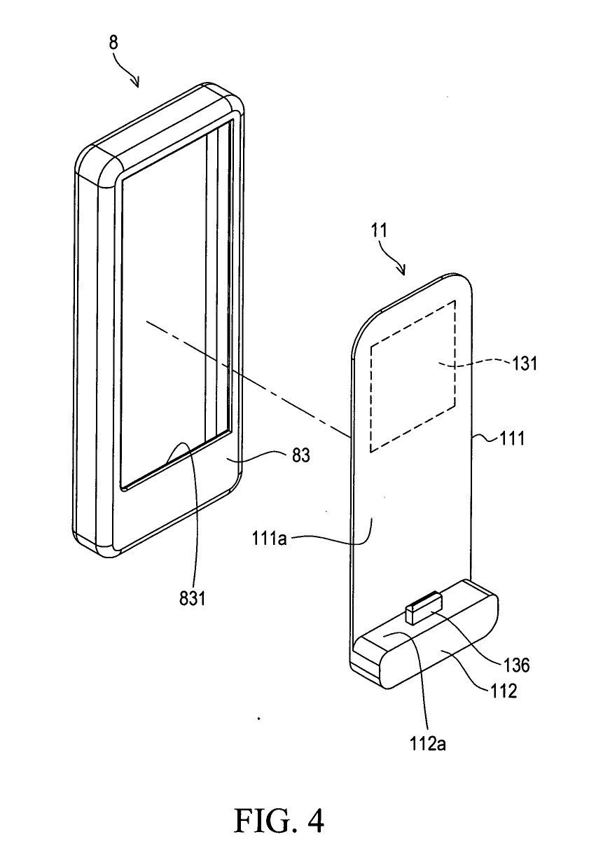

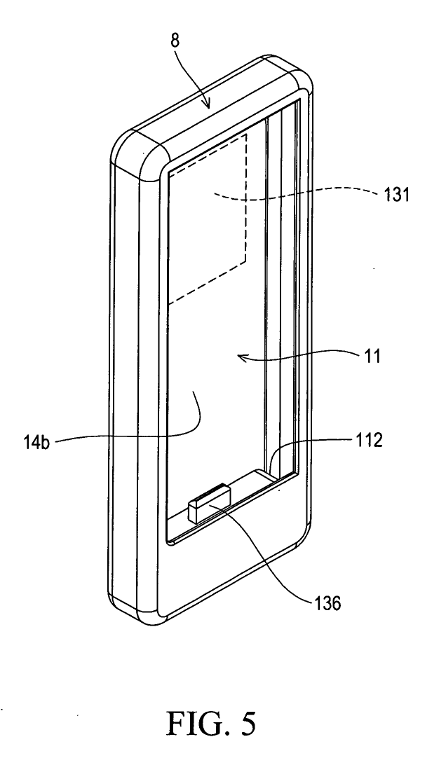

Referring to FIGS. 4, 5, and 6, a bidirectional wireless charging/discharging device according to a second embodiment of the present invention is shown, which is substantially identical to that of the first embodiment discussed above, except that the enclosure member 8 of the second embodiment is made different and the carrier body 11 is structured to omit the holding arms 12 of the first embodiment.

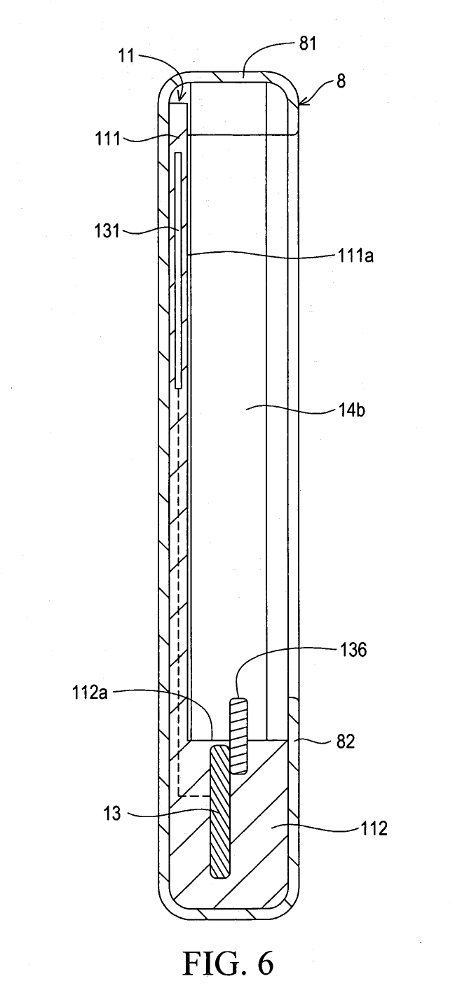

As shown in these drawings, the enclosure member 8 is of an enclosed envelope like configuration, which is hollow and has a front surface 83 forming an opening 831. Besides the seat 112 that has an upper side wall 112a, the carrier body 11 comprises the back board 111 that has a front surface 111a. As shown in FIG. 6, the enclosure member 8 has side walls 81, 82 that define, together with the front surface 111a and the upper side wall 112a of the carrier body 11, a retention zone 14b. The opening 831 of the enclosure member 8 is in communication with the retention zone 14b to allow the handheld electronic device 3 to be positioned in the retention zone 14b. Further, the enclosure member 8 is made of a soft plastic material or leather.

When the handheld electronic device 3 is positioned in the retention zone 14b of the bidirectional wireless charging/discharging device according to the second embodiment of the present invention, the connector 31 is set in electrical connection with the connector 136 to allow charging and discharging to be performed in a wireless manner.

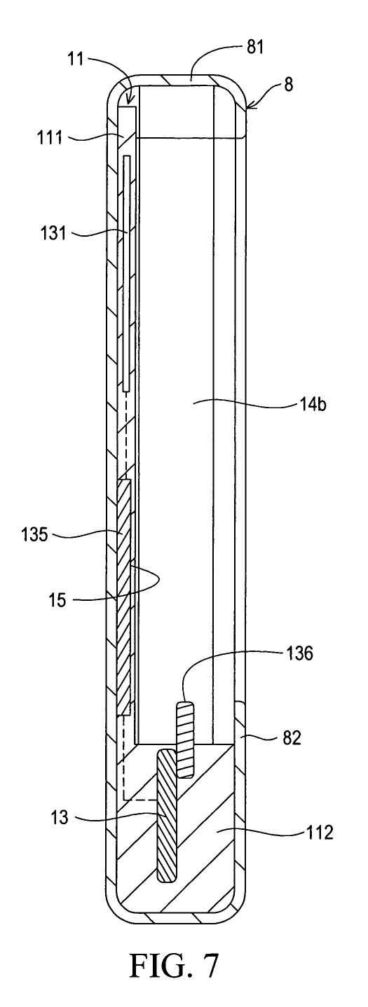

Referring to FIG. 7, the bidirectional wireless charging/discharging device according to the second embodiment of the present invention may be structured so that the first receiver/transmitter device 13 further comprise a first power source device (a rechargeable battery) 135, and the first power source device 135 is arranged inside the back board 111 of the carrier body 11. The arrangement can be embedding the first power source device 135 in the back board 111 (not shown), or alternatively, as shown in the drawing, the back board 111 forms a power source retention chamber 15, whereby the first power source device 135 is accommodated in the power source retention chamber 15 and electrically connects the first receiver/transmitter device 13 to allow electrical power converted to be supplied through the first power source device 135 and the connector 136.

### Bidirectional Wireless Charging/Discharging Circuit

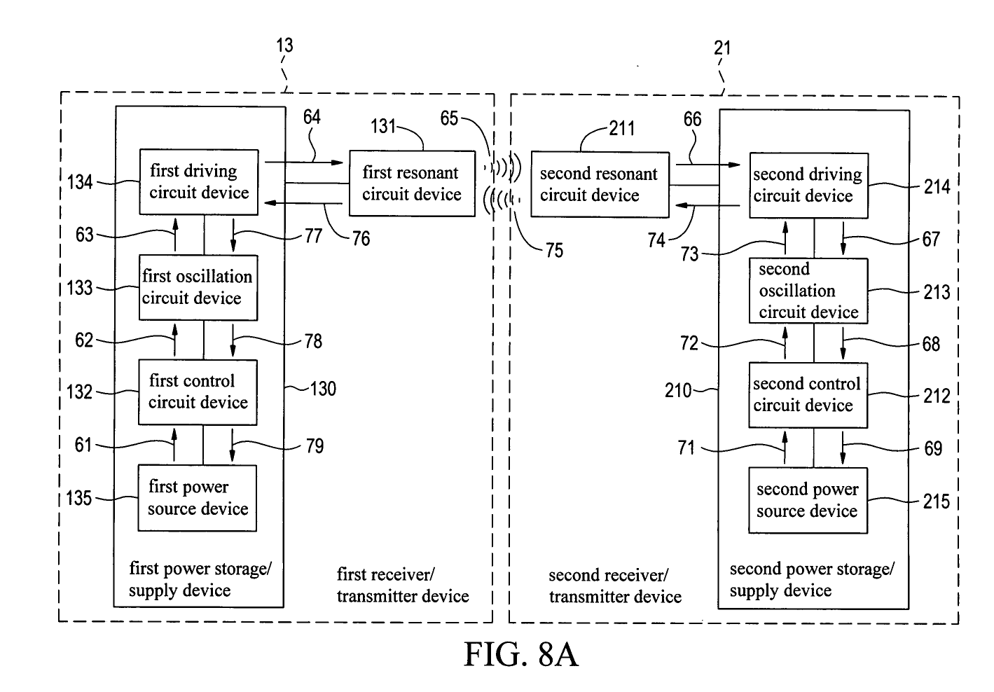

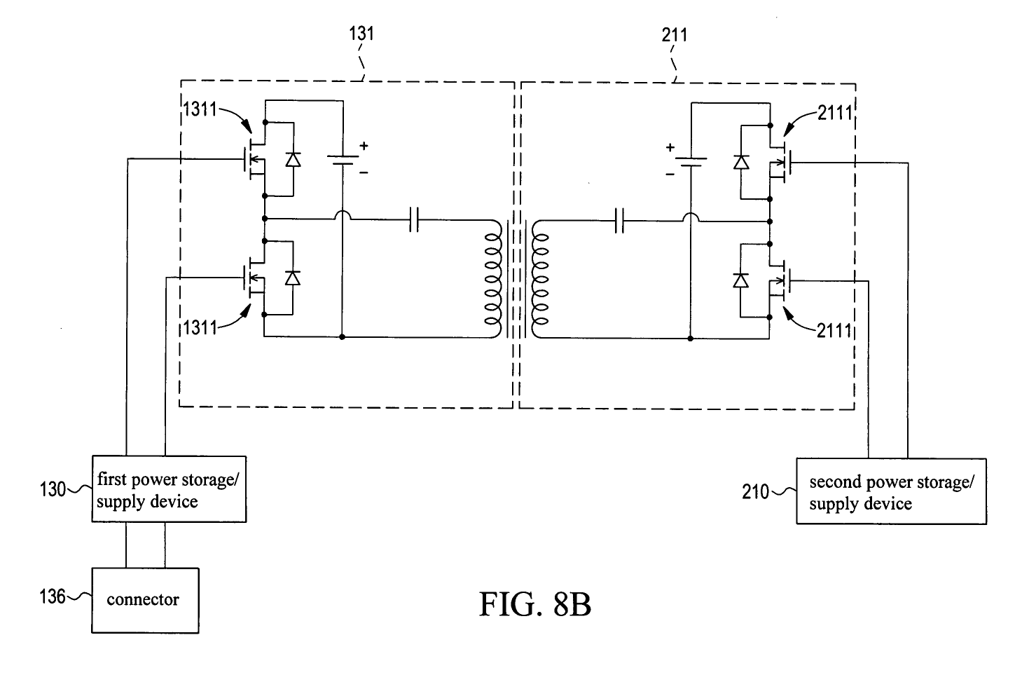

Referring to FIG. 8A, the bidirectional wireless charging/discharging device according the present invention comprises a bidirectional wireless charging/discharging circuit, which comprises: a first receiver/transmitter device 13 that is arranged in the bidirectional wireless charging/discharging device and a second receiver/transmitter device 21 arranged in the corresponding charging/discharging device 2. The first receiver/transmitter device 13 comprises: a first power storage/supply device 130 and a first resonant circuit device 131. The first power storage/supply device 130 supplies a first electrical power 61 and converts the first electrical power 61 into a first frequency modulation signal 64. Preferably, the first power storage/supply device 130 further comprises: a first control circuit device 132, a first oscillation circuit device 133, a first driving circuit device 134. Firstly, the first power storage/supply device 130 supplies the first electrical power 61 from a first power source device 15 (such as a rechargeable battery) thereof and the first control circuit device 132 converts the first electrical power 61 into a first DC (Direct Current) signal 62. The first oscillation circuit device 133 is in electrical connection with the first control circuit device 132 and the first oscillation circuit device 133 receives and converts the first DC signal 62 into a first AC (Alternating Current) signal 63. The first driving circuit device 134 is in electrical connection with the first oscillation circuit device 133 and the first driving circuit device 133 receives and converts the first AC signal 63 into the first frequency modulation signal 64.

Referring to FIG. 8B, which shows a schematic circuit diagram illustrating correspondence between the first resonant circuit device 131 and a second resonant circuit device 211 according to a preferred embodiment of the present invention, the connector 136 mentioned previously is in electrical connection with the first power storage/supply device 130.

The first resonant circuit device 131 is in electrical connection with the first power storage/supply device 130. Preferably, the first resonant circuit device 131 comprises a half-bridge power circuit composed of at least two electrically-connected metal oxide semiconductor field effect transistors (MOSFETs) 1311. When the first resonant circuit device 131 is in an activated state, in which at least one of the MOSFETs 1311 is in an operation condition, the first resonant circuit device 131 is in a transmitting condition. The first resonant circuit device 131 receives and converts the first frequency modulation signal 64 into first resonance energy 65.

The second receiver/transmitter device 21 is arranged to correspond to the first receiver/transmitter device 13. The second receiver/transmitter device 21 comprises: a second resonant circuit device 211 and a second power storage/supply device 210. The second resonant circuit device 211 is arranged to correspond to the first resonant circuit device 131. Preferably, the second resonant circuit device 211 comprises a half-bridge power circuit that is composed of electrically-connected MOSFETs 2111. Under the condition described above, the second resonant circuit device 211 is in a deactivated state, in which all the MOSFETs 2111 are not in an operation condition, and the second resonant circuit device 211 is in a receiving condition. The second resonant circuit device 211 receives and converts the first resonance energy 65 into a third frequency modulation signal 66. The second power storage/supply device 210 is in electrical connection with the second resonant circuit device 211, whereby the second power storage/supply device 210 receives the third frequency modulation signal 66 and converts the third frequency modulation signal 66 into a third electrical power 69 for storage.

Preferably, the second power storage/supply device 210 comprises: a second driving circuit device 214, a second oscillation circuit device 213, and a second control circuit device 212. The second driving circuit device 214 is in electrical connection with the second resonant circuit device 211 and the second driving circuit device 214 receives and converts the third frequency modulation signal 66 into a third AC signal 67. The second oscillation circuit device 213 is in electrical connection with the second driving circuit device 214 and the second oscillation circuit device 213 receives and converts the third AC signal 67 into a third DC signal 68. The second control circuit device 212 is in electrical connection with the second oscillation circuit device 213 and the second control circuit device 212 receives and converts the third DC signal 68 into the third electrical power 69 to be stored in a second power source device 215 (such as a rechargeable battery).

Certainly, the second resonant circuit device 211 can be set in an activated state, in which at least one of the MOSFETs 2111 is in an operation condition, and the second resonant circuit device 211 is now in a transmitting condition; and the first resonant circuit device 131 is correspondingly set in a deactivated state, in which all the MOSFETs 1311 are not in operation condition, and the first resonant circuit device 131 is in a receiving condition. Under this condition, the second power storage/supply device 210 supplies a second electrical power 71 from the second power source device 215 (such as a rechargeable battery) thereof and the second control circuit device 212 converts the second electrical power 71 into a second DC signal 72. The second oscillation circuit device 213 receives and converts the second DC signal 72 into a second AC signal 73. The second driving circuit device 214 receives and converts the second AC signal 73 into a second frequency modulation signal 74. And, under this condition, the second resonant circuit device 211 is in the transmitting condition, and the second resonant circuit device 211 receives and converts the second frequency modulation signal 74 into second resonance energy 75. The first resonant circuit device 131 is in the receiving condition and the first resonant circuit device 131 receives and converts the second resonance energy 75 into a fourth frequency modulation signal 76. The first driving circuit device 134 receives and converts the fourth frequency modulation signal 76 into a fourth AC signal 77. The first oscillation circuit device 133 receives and converts the fourth AC signal 77 into a fourth DC signal 78. The first control circuit device 132 receives and converts the fourth DC signal 78 into a fourth electrical power 79 to be stored in the first power source device 135. As such, the present invention realizes the function of bidirectional wireless charging and discharging.

The circuit of the block diagrams shown in FIGS. 8A and 8B is commonly applicable to both the first and second embodiments of the present invention.

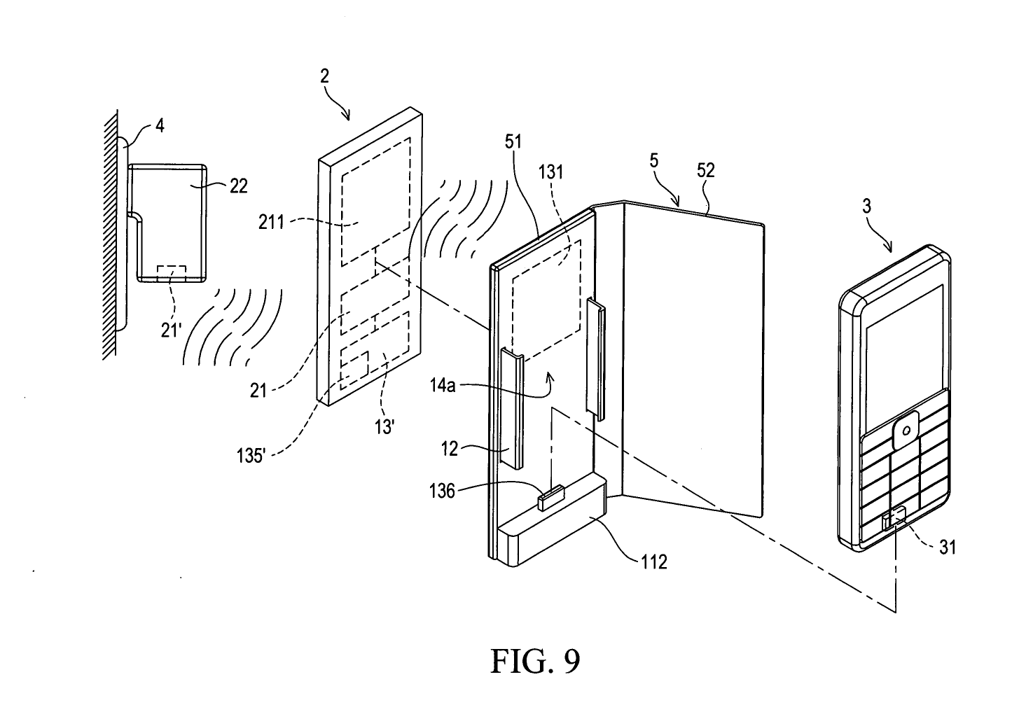

Referring to FIG. 9, the bidirectional wireless charging/discharging device according to the first or second embodiment of the present invention can be used in combination with a corresponding charging/discharging device of different type. As shown, the power member 22 of the corresponding charging/discharging device, which was originally a cabled member, is now replaced by a wireless device and thus a second receiver/transmitter device 21′ is additionally provided. Further, the corresponding charging/discharging device is additionally provided with a first receiver/transmitter device 13′ that has a first power source device (a rechargeable battery) 135′. Thus, the corresponding charging/discharging device and the power member 22 may transmit and receive resonance energy therebetween in a wireless manner, and the resonance energy may then be converted into electrical power to be stored in the first power source device (the rechargeable battery) 135′.

The features of the enclosure bidirectional wireless charging/discharging device according to the present invention are as follows. The device can serve as a common charging and discharging device for various handheld electronic devices (such as mobile phone, PDA, electronic navigation device, MID, and electronic book), so that there is no need for a user to carry a number of different AC-to-DC adaptors, realizing convenience of use and protection against environmental pollution (for no AC-to-DC adaptor is needed and environmental pollution caused by disposed adaptor is substantially reduced). The enclosure member 5, 8 protects and retains various handheld electronic devices 3 received therein. The enclosure member 5, 8 also encloses the carrier body 11 and the handheld electronic device 3 positioned in the bidirectional wireless charging/discharging device to thereby provide better protection and aesthetics. A resonant circuit device, when set in an activated condition, transmits resonance energy, and a corresponding resonant circuit device, when set in deactivated condition, receives the resonance energy, whereby bidirectional wireless charging and discharging of an electronic device can be realized. Further, the first power source device 135, 135′ and the second power source device 215 can both be flexible ultra-thin cell to ensure practicability.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An enclosure bidirectional wireless charging/discharging device, which selectively performs electrical charging and discharging operation through selectively transmitting and receiving resonance energy with respect to a corresponding charging/discharging device that comprises a second receiver/transmitter device, the bidirectional wireless charging/discharging device comprising:
a carrier body;
a first receiver/transmitter device, which is arranged inside the carrier body, the first receiver/transmitter device comprising at least one connector, which is exposed outside the carrier body, the first and second receiver/transmitter devices selectively transmitting to and receiving from each other the resonance energy in a wireless manner, the resonance energy being then converted into electrical power, which is transmitted through the connector, or the electrical power being converted into a resonance energy for transmission and reception in a wireless manner; and
an enclosure member, which encloses the carrier body, the enclosure member and the carrier body together defining a retention zone therebetween.

2. The enclosure directional wireless charging/discharging device as claimed in claim 1, wherein the enclosure member is made of leather and comprises an enclosure sheet and a flap cover connected to a side edge of the enclosure sheet, the enclosure member being arranged to have the enclosure sheet thereof enclosing the carrier body.

3. The enclosure directional wireless charging/discharging device as claimed in claim 2, wherein the carrier body comprises a back board and a seat mounted to a lower edge portion of the back board, the back board forming a pair of holding arms, the connector of the first receiver/transmitter device being exposed on an upper side wall of the seat, the enclosure sheet of the enclosure member having an inside surface that forms two first openings corresponding to the two holding arms and a second opening corresponding to the seat the two holding arms of the carrier body respectively extending through the two first openings to project outside the enclosure member, the seat extending through the second opening to project outside the enclosure member, whereby the two holding arms, the seat, and the inside surface of the enclosure member collectively define the retention zone

4. The enclosure directional wireless charging/discharging device as claimed in claim 2, wherein the enclosure member comprises a spacer plate, which connects between opposing side edges of the enclosure sheet and the flap cover.

5. The enclosure directional wireless charging/discharging device as claimed in claim 1, wherein the enclosure member is of an enclosed envelope like configuration, which is hollow and has a front surface forming an opening, the enclosure member having side walls that define, together with the enclosed carrier body, the opening of the enclosure member being in communication with the retention zone.

6. The enclosure directional wireless charging/discharging device as claimed in claim 5, wherein the carrier body comprises a back board and a seat mounted to a lower edge portion of the back board, the enclosure member having side walls, which define, together with the front surface of the back board of the carrier body and the upper side wall of the seat, the retention zone.

7. The enclosure directional wireless charging/discharging device as claimed in claim 6, wherein the first receiver/transmitter device comprises a first power source device, which is arranged inside the back board of the carrier body, the electrical power being transmitted through the first power source device and the connector.

8. The enclosure directional wireless charging/discharging device as claimed in claim 5, wherein the enclosure member is made of one of soft plastic material and leather.

9. The enclosure directional wireless charging/discharging device as claimed in claim 1, wherein the first receiver/transmitter device comprise a first power storage/supply device and a first resonant circuit device; and the second receiver/transmitter device is arranged to correspond to the first receiver/transmitter device, the second receiver/transmitter device comprising a second resonant circuit device and a second power storage/supply device, wherein:
the first power storage/supply device supplies a first electrical power and converts the first electrical power into a first frequency modulation signal, and also receives a fourth frequency modulation signal and converts the fourth frequency modulation signal into a fourth electrical power for storage, the connector being in electrical connection with the first power storage/supply device;
the first resonant circuit device is in electrical connection with the first power storage/supply device, whereby the first resonant circuit device, when set in an activated state, receives and converts the first frequency modulation signal into first resonance energy, and, when set in a deactivated state, receives and converts second resonance energy into the fourth frequency modulation signal;
the second resonant circuit device is arranged to correspond to the first resonant circuit device, whereby the second resonant circuit device, when set in a deactivated state, receives and converts the first resonance energy into a third frequency modulation signal, and, when set in an activated state, receives and converts a second frequency modulation signal into the second resonance energy; and
the second power storage/supply device is in electrical connection with the second resonant circuit device, the second power storage/supply device receiving the third frequency modulation signal and converting the third frequency modulation signal into a third electrical power for storage, and supplying a second electrical power and converting the second electrical power into the second frequency modulation signal.

10. The enclosure bidirectional wireless charging/discharging device as claimed in claim 9, wherein the first power storage/supply device comprises:
a first control circuit device, which converts the first electrical power into a first DC signal, and receives and converts a fourth DC signal into the fourth electrical power for storage;
a first oscillation circuit device, which is in electrical connection with the first control circuit device, the first oscillation circuit device receiving and converting the first DC signal into a first AC signal, and receiving and converting a fourth AC signal into the fourth DC signal; and
a first driving circuit device, which is in electrical connection with the first oscillation circuit device, the first driving circuit device receiving and converting the first AC signal into the first frequency modulation signal, and receiving and converting the fourth frequency modulation signal into the fourth AC signal.

11. The enclosure bidirectional wireless charging/discharging device as claimed in claim 10, wherein the first power storage/supply device comprises a first power source device, which is in electrical connection with the first control circuit device.

12. The enclosure bidirectional wireless charging/discharging device as claimed in claim 9, wherein the first resonant circuit device comprises at least two metal oxide semiconductor field effect transistors.

13. The enclosure bidirectional wireless charging/discharging device as claimed in claim 12, wherein the activated state comprises at least one of the metal oxide semiconductor field effect transistors being set in an operation condition.

14. The enclosure bidirectional wireless charging/discharging device as claimed in claim 12, wherein the deactivated state comprises the metal oxide semiconductor field effect transistors being all not in an operation condition.

15. The enclosure bidirectional wireless charging/discharging device as claimed in claim 9, wherein the second power storage/supply device comprises:
a second driving circuit device, which is in electrical connection with the second resonant circuit device, the second driving circuit device receiving and converting the third frequency modulation signal into a third AC signal, and receiving and converting a second AC signal into the second frequency modulation signal;
a second oscillation circuit device, which is in electrical connection with the second driving circuit device, the second oscillation circuit device receiving and converting the third AC signal into a third DC signal, and receiving and converting a second DC signal into the second AC signal; and
a second control circuit device, which is in electrical connection with the second oscillation circuit device, the second control circuit device receiving and converting the third DC signal into the third electrical power for storage, and receiving and converting the second electrical power into the second DC signal.

16. The enclosure bidirectional wireless charging/discharging device as claimed in claim 9, wherein the second resonant circuit device comprises at least two metal oxide semiconductor field effect transistors.

17. The enclosure bidirectional wireless charging/discharging device as claimed in claim 16, wherein the activated state comprises at least one of the metal oxide semiconductor field effect transistors being set in an operation condition

18. The enclosure bidirectional wireless charging/discharging device as claimed in claim 16, wherein the deactivated state comprises the metal oxide semiconductor field effect transistors being all not in an operation condition.
